(19) United States
(12) Patent Application Publication
(10) Pub. No.: US 2020/0062495 A1
(43) Pub. Date: Feb. 27, 2020

(54) CAPSULE COMPRISING A PARTICULATE COMPOSITION FOR USE IN A COFFEE BREWING APPARATUS

(71) Applicant: FrieslandCampina Nederland B.V., Amersfoort (NL)

(72) Inventors: Ivan ANTON ANTON, Wageningen (NL); Anders Erik Ingmar LINDQVIST, Wageningen (NL); Paul Bastiaan VAN SEEVENTER, Wageningen (NL)

(21) Appl. No.: 16/349,908

(22) PCT Filed: Nov. 13, 2017
(86) PCT No.: PCT/EP2017/079050

§ 371 Date: May 14, 2019

(30) Foreign Application Priority Data
Nov. 15, 2016 (EP) 16198972.8

(51) Int. Cl. B65D 85/804; A23C 9/16; A47J 31/40; A23F 5/26

(52) U.S. Cl. CPC B65D 85/8043; A23C 9/16; A23F 5/267; A23F 5/262; A47J 31/407

(57) ABSTRACT

The invention relates to a sealed capsule for use in a coffee brewing apparatus, the capsule comprising a particulate composition comprising: (a) 8-32 wt. % fat; (b) 15-29 wt. % milk protein; (c) 40-60 wt. % of disaccharide, comprising, by weight of the disaccharide, (i) 46-78 wt. % lactose; and (ii) 22-54 wt. % sucrose. The capsules according to the present invention offer the advantage that the particulate composition contained therein is essentially fully converted into a hot creamy and/or milky liquid with excellent foaming properties, mouthfeel, whitening power and taste.

### TECHNICAL FIELD OF THE INVENTION

The invention relates to a sealed capsule comprising a particulate composition for use in a coffee brewing apparatus, especially a coffee capsule machine that produces hot coffee brew by injecting hot water under high pressure into the capsule. Coffee capsule machines of this type are sold under different brand names, such as Nespresso®, Dolce Gusto®, K-Fee® and Lavazza Blue®.

The sealed capsule of the present invention contains a particulate composition and can be used to prepare a hot creamy liquid in the aforementioned coffee brewing apparatus. This hot creamy liquid can be combined with hot coffee to prepare hot coffee drinks such as cappuccino and coffee cortado.

### BACKGROUND OF THE INVENTION

EP-A 2 123 164 describes a granulated dairy product comprising dry emulsified fat particles that are agglomerated together and at least partially coated with a first binding medium comprising a carbohydrate, so as to form coated agglomerate granules of mean particle diameter between 10 μm and 10000 μm,

GB-A 2 381 731 describes a powdered beverage whitener composition comprising, by weight based the dry weight of the composition: from about 50% to about 80% of a milk powder; from about 5% to about 30% of whey solids, and from about 10% to about 30% of one or more added sugars.

U.S. Pat. No. 6,026,732 describes capsules containing a substance to be extracted for preparation of a drink, wherein the capsules comprise a cup, a cover and a lip and wherein the cup sidewall extends to the cover and lip. These capsules can be used to prepare drinks in a device that is configured for containing a capsule during extraction and that comprises a member for injecting water into the capsule for extraction of the substance in the capsule under pressure. The capsules described in U.S. Pat. No. 6,026,732 are especially designed to hold roasted, ground coffee.

Pads comprising instant dairy creamer and their use in the preparation of coffee drinks such as cappuccino, are known in the art. These pads can be used in a coffee brewing machines to produce a foamy liquid which may be combined with hot coffee.

WO 2006/043102 describes a flexible pad for preparing a beverage comprising: a filter bag defining a storage volume; the storage volume containing a water-soluble composition for forming a beverage; wherein the storage volume further contains a plurality of non-soluble absorbent particles. The water-soluble composition within the storage volume can be a milk powder or a creamer powder. The flexible pads described in WO 2006/043102 are not suitable for use in high pressure coffee brewing machines.

WO 2011/039027 describes a pad for the preparation of a drink suitable for consumption comprising: a storage volume, this storage volume comprising a water-soluble powder, the mean size of the powder particles being greater than or equal to 0.7 mm. The water-soluble powder can be milk powder of creamer powder. The size of the particles of powder make it possible to optimize the capability of dissolution by steam or by hot water, preventing in particular the creation of preferred passages within the product, passages which prevent homogeneous wetting and homogeneous dissolution of the product.

Capsules for the preparation of hot milk liquid in K-Fee® coffee capsule machines are sold under the brand name K-Fee Espresto® and K-Fee Espressi®. These capsules have an internal volume of 20 ml and contain 10 grams of an instant milk product.

A technical challenge associated with the use of instant creamer capsules in coffee brewing machines arises from the fact that such machines are designed for quick extraction of taste components from ground coffee in coffee capsules, and are not built for quick complete dissolution of instant creamers.

### SUMMARY OF THE INVENTION

The inventors have developed a capsule with content that can be used in conventional coffee brewing machines using disposable capsules to produce hot milk-containing coffee drinks of excellent quality. Thus, the use of perishable liquid milk can be avoided.

This capsule comprises a particulate composition that readily dissolves when it is injected with hot pressurised water during normal operation of these coffee brewing machines and that is dispensed from the capsule in the form of a creamy liquid that can be used in the preparation of hot milk-containing coffee, chocolate or tea drinks of excellent quality.

More particularly, the inventors have developed a sealed capsule comprising a particulate composition that contains:
8-32 wt. % fat;
15-29 wt. % milk protein;
40-60 wt. % of disaccharide, said disaccharide comprising by weight of the disaccharide:
   46-78 wt. % lactose;
   22-55 wt. % sucrose.

The capsules according to the present invention offer the advantage that the particulate composition contained therein is essentially fully converted into a hot creamy and/or milky liquid with excellent foaming properties, mouthfeel, whitening power and taste.

The particulate composition in the capsule is able to deliver a very high amount of milk solids in the drink, which is essential for achieving a creamy liquid having the aforementioned desired organoleptic properties, given the small internal volume of the capsule. The particulate composition is able to be rapidly dissolved and completely removed from the capsule when used in a coffee brewing machine.

### DETAILED DESCRIPTION OF THE INVENTION

A first aspect of the present invention relates to a sealed capsule for use in a coffee brewing apparatus, said capsule comprising a particulate composition, said composition containing:
a. 8-32 wt. % fat;
b. 15-29 wt. % milk protein;
c. 40-60 wt. % of disaccharide, said disaccharide comprising by weight of the disaccharide:
   i. 46-78 wt. % lactose;
   ii. 22-54 wt. % sucrose.

The term “fat” as used herein refers to lipids selected from the group of triglycerides, diglycerides, monoglycerides, phosphatides, fatty acids and combinations thereof.

The term “milk protein” as used herein refers to proteins that are naturally present in bovine milk. Caseins and whey proteins (e.g., beta-lactoglobulin and alpha-lactalbumin) are examples of milk protein.

The unit “Sauter mean diameter” (D[3,2]) as used herein can be determined using a Malvern Mastersizer 2000.

The unit “volume weighted average particle size” (D[4,3]) as used herein can be determined using a Malvern Mastersizer 2000.

The units d₁₀, d₅₀ and d₉₀, as used herein can be determined by using laser light scattering to measure the particle size distribution. A suitable machine for performing such measurements is the Malvern Mastersizer 2000. The d₅₀, the median, is defined as the diameter where half of the population lies below this value. Similarly, 90 percent of the distribution lies below the d₉₀, and 10 percent of the population lies below the d₁₀.

The unit “poured bulk density” as used herein can be determined by measuring the weight that 500 ml of a particulate composition weighs, directly after pouring the particulate composition into a 500 ml calibrated stationary cylinder [Seedburo Equipment Co] having a length of 9.2 cm and a diameter of 7.7 cm. The poured bulk density is thus measured without tapping the particulate composition after pouring the particulate composition into the cylinder.

The benefits of the present invention are particularly appreciated in case the inner volume of the capsule is relatively small, e.g. not more than 20 ml. Preferably, the capsule has an inner volume between 5 and 18 ml, more preferably between 10 and 15 ml.

Typically, the capsule of the present invention contains 4-8 grams, more preferably 5-7 grams of the particulate composition.

The poured bulk density of the particulate composition typically lies in the range of 380-550 WI, more preferably in the range of 410-525 WI.

The combination of fat, milk protein and disaccharide typically constitutes at least 85 wt. %, more preferably at least 90 wt. % of the particulate composition.

The fat content of the particulate composition preferably is within the range of 9-27 wt. %, more preferably in the range of 11-25 wt. % and most preferably in the range of 13-23 wt. %.

The fat in the particulate composition preferably is a vegetable fat or a milk fat, more preferably the fat in the particulate composition is a milk fat, preferably bovine milk fat. Preferably, the milk fat is derived from milk cream.

The particulate composition preferably contains at least 8 wt. %, more preferably at least 12 wt. % milk fat. Milk fat typically constitutes the bulk of the fat contained in the particulate composition. Preferably, milk fat constitutes at least 80 wt. %, more preferably at least 90 wt. %, even more preferably at least 95 wt. % of the fat in the particulate composition. Most preferably, all the fat contained in the particulate composition is milk fat.

The particulate composition of the present invention preferably contains no phosphatides other than those naturally present in fat and protein components used in the manufacture of the particulate composition. Accordingly, the particulate composition typically contains 0.05-0.4 wt. % phosphatides, more preferably 0.1-0.33 wt. % phosphatides.

Milk protein is preferably contained in the particulate composition in a concentration of 16-28 wt. %, more preferably of 18-26 wt. % and most preferably of 20-24 wt. % by weight of the particulate composition.

Milk protein typically constitutes the bulk of the protein contained in the particulate composition. Preferably, milk protein constitutes at least 80 wt. %, more preferably at least 90 wt. %, even more preferably at least 95 wt. % of the protein in the particulate composition. Most preferably, all the protein contained in the particulate composition is milk protein.

Typically, the milk protein contained in the particulate composition contains 77-83% casein by weight of milk protein and 17-23% whey protein by weight of milk protein. More preferably, the particulate composition contains 78-82% casein by weight of milk protein and 18-22% whey protein by weight of milk protein. Together, casein and whey protein typically represent at least 90 wt. %, more preferably at least 95 wt. % of the milk protein that is present in the particulate composition.

The inventors have found that the whitening and/or foaming properties of the particulate composition are dependent on the fat:milk protein ratio in the composition. Very good whitening and/or foaming properties can be achieved if fat and milk protein are contained in the particulate composition in a weight ratio that is in the range of 1:1.3 to 2.8:1, preferably in a weight ratio of 1:1.2 to 2:1.

The disaccharide content of the particulate composition is preferably in the range of 40-55 wt. %, more preferably in the range of 45-50 wt. %.

The particulate composition preferably contains 48-70%, more preferably 50-65% and most preferably 55-60% lactose by weight of disaccharides.

The sucrose content of the particulate composition is preferably in the range of 25-50%, more preferably 30-47% and most preferably 35-45% by weight of disaccharides.

Together, lactose and sucrose typically constitute at least 90 wt. %, more preferably at least 95 wt. % and most preferably at least 99.5 wt. % of the disaccharides contained in the particulate composition.

The particulate composition of the present invention may preferably comprise up to 1.5 wt. % of sodium chloride. Sodium chloride may suitably be incorporated in the particulate composition for taste enhancement.

In a preferred embodiment of the present invention, the sealed capsule is particularly suitable for a cappuccino beverage, wherein the sealed capsule comprises a particulate composition that contains:
a. 20-26 wt. % milk fat;
b. 17-24 wt. % milk protein;
c. 42-52 wt. % of disaccharide, said disaccharide comprising by weight of the disaccharide:
   i. 52-64 wt. % lactose;
   ii. 22-45 wt. % sucrose.

In another preferred embodiment of the present invention, the sealed capsule is particularly suitable for an extra creamy beverage, wherein the sealed capsule comprises a particulate composition that contains:
a. 25-32 wt. % milk fat;
b. 17-23 wt. % milk protein;
c. 42-48 wt. % of disaccharide, said disaccharide comprising by weight of the disaccharide:
   i. 57-64 wt. % lactose;
   ii. 35-40 wt. % sucrose.

In yet another preferred embodiment of the present invention, the sealed capsule is particularly suitable for an extra milky beverage, wherein the sealed capsule comprises a particulate composition that contains:
a. 8-15 wt % milk fat;
b. 22-28 wt. % milk protein;
c. 54-60 wt. % of disaccharide, said disaccharide comprising by weight of the disaccharide:
   i. 68-72 wt. % lactose;
   ii. 27-33 wt. % sucrose.

In accordance with a particularly preferred embodiment the particulate composition comprises 77.5-100 wt. % of spray dried particles containing:
8-33 wt. % fat;
15-29 wt. % milk protein;
18-47 wt. % lactose; and
7-18 wt. % sucrose.

More preferably, the spray dried particles contain:
15-30 wt. % fat;
18-26 wt. % milk protein;
25-42 wt. % lactose; and
8-17 wt. % sucrose.

Most preferably, the spray dried particles contain:
20-25 wt. % fat;
22-24 wt. % milk protein;
33-37 wt. % lactose; and
9-16 wt. % sucrose.

Besides the aforementioned spray dried particles the particulate composition may optionally contain up to 22.5 wt. % of sucrose particles. The sucrose particles are preferably in the form of crystalline sucrose particles.

The sucrose particles in the particulate composition preferably have a d₈₅ in the range of 1-500 μm, more preferably in the range of 10-450 μm and most preferably in the range of 50-400 μm. The unit d₈₅ can be determined using the DIN 66141 method.

The inventors have found that a particulate composition that produces a hot creamy liquid of excellent quality can be obtained by combining spray dried particles containing fat, milk protein, lactose and sucrose with sucrose particles. Accordingly, in a particularly preferred embodiment, the particulate composition comprises 80-98 wt. % of the spray dried particles; and 2-20 wt. % of sucrose particles. Even more preferably, the particulate composition comprises 85-90 wt. % of the spray dried particles; and 10-15 wt. % of sucrose particles.

The inventors have found that agglomerated spray dried particles offer the advantage that they enable the production of a particulate composition that combines a relatively high bulk density with excellent dissolution properties. Accordingly, in another particularly preferred embodiment, the spray dried particles in the particulate composition are agglomerates composed of a plurality of smaller spray dried particles of the same composition.

The agglomerated spray dried particles preferably have a Sauter mean diameter (D[3,2]) in the range of 50-250 μm, more preferably in the range of 90-200 μm and most preferably in the range of 120-180 μm.

The agglomerated spray dried particles preferably have a volume weighted average particle size (D[4,3]) which ranges from 150-450 μm, more preferably ranges from 200-400 μm, most preferably ranges from 250-350 μm.

Typically, the agglomerated spray dried particles have a d₁₀ between 40-100 μm, more preferably between 40-80 μm and most preferably between 50-60 μm. Typically, the agglomerated spray dried particles have a d₅₀ between 140-300 μm, more preferably between 150-290 μm and most preferably between 160-280 μm. Typically, the agglomerated spray dried particles have a d₅₀ between 350-700 μm, more preferably between 380-650 μm and most preferably between 400-600 μm.

The particulate composition of the invention is preferably prepared by a process comprising the steps of:
combining condensed skimmed milk, sucrose, milk cream and milk powder, to prepare a pre-emulsion containing 55-65 wt. % dry matter, including by weight of dry matter:
   15-29 wt. % of milk protein;
   8-33 wt. % of milk fat;
   18-47 wt. % of lactose; and
   7-18 wt. % of sucrose;
homogenizing the pre-emulsion in a homogenization step at a temperature between 55-70° C. and at a pressure between 5-60 bar to obtain an emulsion;
spray drying the emulsion to produce a semi-dried powder having a water content of at least 5 wt. % water;
agglomerating and further drying the semi-dried powder to produce agglomerates having a water content of less than 5 wt. % water.

The milk powder employed in the present process preferably is skim milk powder.

The process preferably comprises the additional step of mixing of 77.5-99 parts by weight of the agglomerates with 1-22.5 parts by weight of sucrose particles.

The capsule of the present invention preferably comprises a capsule body to accommodate the particulate composition and a sealing cover to seal the particulate composition in the capsule body. During preparation in a coffee brewing apparatus, hot water is injected into the capsule body, and the sealing cover is arranged to be perforated in a predefined pattern by the internal pressure.

More preferably, the capsule body comprises a base (e.g. a circular base), a lateral sidewall extending from the base to form a (circular) capsule aperture opposite to the base, and a lip extending laterally away from the lateral sidewall. The sealing cover is preferably attached to the lip surrounding the capsule aperture.

A typical example of such a capsule body and sealing cover is described in U.S. Pat. No. 6,026,732.

The capsule body preferably comprises one or more materials selected from aluminium, plastic materials and combinations thereof. Suitable plastic materials are polypropylene (PP), polyethylene (PE), polybutylene terephthalate (PBT) or polyethylene terephthalate (PET). Preferably the capsule body is made of plastic, since aluminium capsules perform less well because these tend to bulge during operation in the coffee machine, leading to pressure drop in the capsule. An example of a suitable plastic capsule type is New Pod EVO Oxygen Barrier (37 mm diameter) from Bisio Progetti, Italy. Sealing cover material for the purpose of the invention can also be obtained from Bisio Progetti, Italy.

The sealing cover preferably comprises one or more materials selected from aluminium, paper, plastic material and combinations thereof, preferably in one or more (laminated) layers. Preferably, the sealing cover comprises aluminium and preferably has a thickness between 5-100 micron. More preferably the sealing cover is made of aluminium and has a thickness between 5-60 micron, most preferably between 20-45 micron.

The capsule body and the sealing cover preferably are substantially impermeable to oxygen. The diameter of the circular capsule aperture is preferably between 24-60 mm, more preferably the diameter of the capsule aperture is between 28-55 mm and most preferably the diameter of the capsule aperture is between 32-50 mm.

The height of the sealed capsule is preferably between 10-40 mm, more preferably between 12-30 mm and most preferably between 15-25 mm.

The sidewall is preferably substantially frustoconical in shape. Accordingly, the ratio between the diameter of the capsule aperture and the diameter of the capsule base is at least 1.05:1, more preferably this ratio is between 1.1:1 and 2:1.

In a preferred embodiment the thickness of each of the circular base, lateral sidewall and lip are greater than the thickness of the cup cover.

In accordance with a particularly preferred embodiment, the capsule of the present invention is not completely filled with the particulate composition. The inventors have found that by not completely filling the capsule, the dissolution of the particulate composition can be substantially improved. Accordingly, in a preferred embodiment, the capsule contains at least 5 vol. %, more preferably at least 6 vol. % and most preferably 8-10 vol. % headspace.

The gas tight void volume (GTVV) of the particulate composition is preferably less than 15%, more preferably less than 10% and most preferably less than 8%. The GTVV can be suitable determined using a gas pycnometer (Accupyc1340, Micrometrics Instrument Corporation, Norcross, Ga., USA).

Gas tight void volume is the percentage of gas tight voids within powders. It is calculated from the closed pore volume (%) according to the formula below.

Gas tight void volume (%) GTVV=ρ_{Measured}*CPV*100

CPV=closed pore volume (ml/g)

Closed pore volume (ml/g) is obtained by subtracting the theoretical volume from the measured volume for a fixed amount of powder. CPV can also be calculated as follows:

$$CPV = \frac{1}{{ρ}_{Measured} } - \frac{1}{{ρ}_{Theoretical} }$$

ρ_{Measured}=Measured density of powder (g/ml)

ρ_{Theoretical}=Theoretical density of powder (g/ml) (without any closed pore volume)

ρ_{Measured} is determined using a gas pycnometer

ρ_{Theoretical} is estimated using the following assumptions

Assumptions

| | |
|---|---|
| ρ moisture (g/ml) | 1 |
| ρ fat (g/ml) | 0.95 |
| ρ protein (g/ml) | 1.3 |
| ρ ash (g/ml) | 2 |
| ρ carbohydrate (g/ml) | 1.55 |

The carbohydrate content of the particulate composition is assumed to be equal to the remainder of the composition after moisture, fat, protein and ash have been accounted for.
Another aspect of the present invention relates to a method for preparing a hot creamy liquid, said method comprising the steps of:
   placing the sealed capsule according to present invention in a coffee brewing apparatus,
   injecting hot water at a pressure of 4 bar to 20 bar into the capsule to form a hot creamy liquid, and
   dispensing the hot creamy liquid from the capsule.

The coffee brewing apparatus in the method of the invention, which applies injection of hot pressurized water into a sealed capsule, is typically a standard needle coffee machine, such as the Nespresso® machine. An example of such a standard needle coffee machine is described in U.S. Pat. No. 6,026,732.

Typically, during the injecting of hot pressurized water into the sealed capsule, the sealing cover is pressed against projections present in the apparatus. Due to the increasing pressure within the capsule and the presence of the projections, the sealing cover deforms and breaks to form a plurality of openings in the sealing cover, which plurality of openings allow the dispensing of the hot creamy liquid from the capsule.

The hot water is preferably injected at a pressure of 6 bar to 19 bar, more preferably the hot water is injected at a pressure of 8 bar to 18 bar and most preferably the hot water is injected at a pressure of 10 bar to 17 bar.

Typically, in the present method 30-100 ml of hot creamy liquid is dispensed from the capsule. More preferably, 35-90 ml and most preferably 40-80 hot creamy liquid is dispensed from the capsule.

The sealed capsules of the present invention offer the important advantage that particulate composition is essentially completely removed from the capsule with the hot creamy liquid. Accordingly, in a preferred embodiment, at least 85 wt. %, more preferably at least 90 wt. % and most preferably at least 99.5 wt. % of the particulate composition is removed from the capsule with the hot creamy liquid.

According to a particularly preferred embodiment, the particulate composition that is contained in the capsule according to the present invention has excellent dissolution properties as evidenced by a high extraction rate (see Examples) According to a particularly preferred embodiment, the particulate composition has an extraction rate of at least 75%, more preferably of at least 80% and most preferably of at least 82%. The extraction rate of the composition is determined by:
filling plastic capsules from Bisio Progetti, Italy, New Pod EVO Oxygen Barrier (diameter 37 mm, volume 12.6 ml) with the particulate composition, leaving a headspace in the capsule of 2 mm (9 vol. %)
sealing the capsules with the aluminium cover seal from Bisio Progetti, supplied with the capsules
introducing the capsule into a Nespresso® Citiz C111 produced by Magimix
brewing the capsules using the espresso dosing volume, according to factory settings (40 ml)
determining the extraction rate using the procedure and equations described in the Examples.

Even the milk protein in the particulate composition is rapidly dispersed/dissolved when the sealed capsule of the present invention is used to prepare the hot creamy liquid. Accordingly, in a preferred embodiment, at least 85 wt. %, more preferably at least 90 wt. % and most preferably at least 99.5 wt. % of the milk protein in the particulate composition is removed from the capsule with the hot creamy liquid. Typically, a hot creamy liquid is obtained which comprises a least 950 mg of milk protein per 40 ml. More preferably, a hot creamy liquid is obtained which comprises a least 1200 mg of protein, most preferably at least 1500 mg of milk protein per 40 ml.

Also the fat in the particulate composition is rapidly dispersed when the sealed capsule of the present invention is used to prepare the hot creamy liquid. Accordingly, in a preferred embodiment, at least 85 wt. %, more preferably at least 90 wt. % and most preferably at least 99.5 wt. % of the fat in the particulate composition is removed from the capsule with the hot creamy liquid. Typically, a hot creamy liquid is obtained which comprises a least 500 mg of fat per 40 ml. More preferably, a hot creamy liquid is obtained which comprises a least 1100 mg of fat, most preferably at least 1200 mg of fat per 40 ml.

It should be noted that in particular the protein and the fat contribute to the excellent sensory properties of the (hot) creamy liquid obtained using the particulate composition contained in the sealed capsule.

In another preferred embodiment the method comprises the preparation of a hot coffee beverage by introducing a capsule containing coffee material into the coffee brewing apparatus and dispensing hot coffee into a beverage container and wherein the hot creamy liquid is dispensed into the same beverage container before or after the hot coffee. Examples of hot coffee beverages that can be prepared by this method include cappuccino or coffee cortado.

In a similar fashion, the sealed capsule of the present invention containing the particulate composition can be preferably used for preparing hot chocolate or tea beverages.

Yet another aspect of the present invention relates to the use of the sealed capsule of the present invention for preparing a hot creamy and/or milky liquid. Preferably the use of the sealed capsule is for preparing a hot creamy liquid.

Preferably, the hot creamy liquid is mixed with brewed coffee to prepare a hot coffee beverage, more preferably a hot coffee beverage selected from cappuccino or coffee cortado.

Alternatively, the hot creamy liquid is preferably mixed with hot tea to prepare a hot tea beverage.

Further, the hot creamy liquid is preferably mixed with hot chocolate or instant powder for hot chocolate to prepare a hot chocolate beverage.

The invention is further illustrated by the following non-limiting examples.

### EXAMPLES

### Example 1

A pre-emulsion was made at 60° C. in the following way:

19.5 kg sucrose (13.4 wt. %) was dissolved in 65.1 kg (15.7 wt. %) of condensed skim milk. Next, 95.1 kg (29.6 wt. %) of milk cream (40 wt. % fat) was added. Finally, 62.7 kg (41.4 wt. %) of skim milk powder was added.

The pre-emulsion was homogenized at 65° C. and 80/30 bar, after which it was spray dried on a Filtermat dryer (GEA), with an inlet temperature of 140° C., and a nozzle pressure of 88 bar. The subsequent agglomeration and final drying was done on the mat using a temperature of 50° c.

The powder so obtained had the following composition:
Milk protein 24 wt %
Fat 26 wt %
Lactose 30 wt. %
Sucrose 13 wt. %

The powder had a poured bulk density of 536 g/L and a GTVV of 7%.

The powder was filled into plastic capsules from Bisio Progetti, Italy, New Pod EVO Oxygen Barrier, diameter 37 mm, volume 12.6 ml. The headspace left in the capsule after filling was 2 mm (9 vol. %). The capsules were sealed with aluminium cover seal from Bisio Progetti, supplied with the capsules.

### Example 2

The capsule of Example 1 was compared with identical capsules that had been filled with commercially available instant creamer or milk powder, also leaving a headspace of 2 mm (9 volume %) in each capsule.

The products tested are shown in Table 1.

TABLE 1

| Sample | Powder | Grams in capsule |
|---|---|---|
| 1 | Powder of Example 1 | 6.2 |
| A | Espressi ® powder¹ | 5.0 |
| B | Coffee Gold cream² | 5.2 |
| C | Regilait ® skim milk powder³ | 3.5 |
| D | Agglomerated skim milk powder⁴ | 5.1 |
| E | Standard skim milk powder⁴ | 6.5 |
| F | Standard skim milk powder⁴ with 17% sugar | 6.9 |
| G | Instant whole milk powder⁴ | 5.0 |
| H | Standard whole milk powder⁴ | 5.5 |
| I | Standard whole milk powder⁴ with 17% | 6.7 |
| | sugar | |

¹Ex K-fee
²Ex Coffee productions S.L., Spain
³Ex Regilait, France
⁴Ex FrieslandCampina, Netherlands

The bulk density and particle size distribution of each of the products is shown in Table 2.

TABLE 2

| | d₁₀ | d₅₀ | d₉₀ | D[3, 2] | D[4, 3] | Poured bulk |
|---|---|---|---|---|---|---|
| Sample | (μm) | (μm) | (μm) | (μm) | (μm) | density (g/L) |
| 1 | 47 | 155 | 380 | 92 | 201 | 536 |
| A | 64 | 154 | 317 | 112 | 182 | 441 |
| B | 41 | 106 | 241 | 71 | 131 | 457 |
| C | 260 | 1470 | 2570 | 606 | 1490 | 305 |
| D | — | — | — | — | — | 447 |
| E | 32 | 92 | 333 | 64 | 162 | 569 |
| F | 36 | 108 | 541 | 74 | 204 | 606 |
| G | 79 | 203 | 556 | 153 | 274 | 438 |
| H | 43 | 136 | 387 | 90 | 184 | 483 |
| I | 47 | 162 | 532 | 102 | 233 | 606 |

The powder extraction rate for each of the capsules was measured using a Nespresso® Citiz C111 produced by Magimix:
1. The capsules were brewed using the espresso dosing volume, according to factory settings (40 ml)
2. The smell, mouthfeel, milky/creamy sensation and overall liking of the liquid brews was evaluated by an expert panel (7 panel members) and scored on a scale of 1 (bad) to 5 (excellent)
3. The liquid brews were collected and weighed for later calculations
4. The gas tight void volume (GTVV) and extraction rate were determined

Extraction rate was determined by first measuring the dry matter content of liquid brews using the burned sand method:
5 g of the liquid brew is dispersed in a beaker containing 25 g of burned sand ((Sand, Fontainebleau, VWR Chemicals, USA).
The beaker is placed in an oven at 103° C. for 3 hours.
By weighing the beaker the concentration of the brewing can be calculated according to equation below.

$$Dry matter ( \% ) = 100 \% * \frac{Weight beaker after drying - Weight of beaker with only sand}{Weight beaker with liquid - Weight of beaker with only sand}$$

The extraction rate is calculated by using the following formula:

$$Extraction rate ( \% ) = 100 \% * \frac{Weight of brewed liquid ( g ) * Dry {matter}^{1} ( \% )}{Weight powder in capsule ( g ) \times ( 100 \% - {moisture}^{2} ( \% ) )}$$

The results of the panel evaluation are shown in Table 3.

TABLE 3

| | | | | Milky/ | |
|---|---|---|---|---|---|
| | | | | creamy | |
| Sample | Whiteness | Smell | Mouthfeel | sensation | Overall liking |
| 1 | 3.8 | 4.0 | 4.5 | 4.4 | Milky, creamy, |
| | | | | | full of taste, long |
| | | | | | lasting, balanced |
| A | 0.8 | 3.6 | 3.6 | 2.3 | Too sweet, too |
| | | | | | salty, caramel |
| B | 4.2 | 2.7 | 2.5 | 3.0 | Off-taste |
| C | 3.7 | 3.2 | 2.8 | 2.7 | Milky, off-taste |
| D | 3.4 | 2.4 | 2.7 | 2.7 | Off-taste |
| E | 3.8 | 1.8 | 2.0 | 1.3 | Watery |
| F | 3.5 | 3.2 | 1.7 | 2.0 | Watery, off-taste |
| G | 3.2 | 3.2 | 2.8 | 3.4 | Milky, watery |
| H | 3.6 | 2.5 | 1.3 | 1.7 | Watery |
| I | 3.5 | 2.0 | 3.0 | 3.1 | Milky, off-taste |

The extraction rates and GTVV's for the capsules are summarised in Table 4.

TABLE 4

| | Extraction | |
|---|---|---|
| Sample | rate (%) | GTVV (%) |
| 1 | 87 | 7.1 |
| A | 87 | 19.3 |
| B | 66 | 12.8 |
| C | 94 | n.d. |
| D | 41 | 15.7 |
| E | 36 | 19.3 |
| F | 46 | n.d. |
| G | 82 | 9.3 |
| H | 40 | 14.8 |
| I | 39 | n.d. |

n.d. = not determined

### Example 3

Example 2 was repeated, except that this time the liquid brews were used to prepare coffee cortado. This was done by first producing 40 ml of the liquid brews using the capsule containing the instant creamer or milk powder, and subsequently adding 40 ml of espresso that had been brewed in the same brewing machine using an espresso coffee capsule (l'Or Espresso Forza, ex Douwe Egberts, the Netherlands).

Several sensory attributes of the coffee cortado's so produced were evaluated by an expert panel (7 panel members). These attributes were scored on a scale of 0 to 5. The results are shown in Table 5.

TABLE 5

| | | | | | Milky/creamy | Coffee | Overall |
|---|---|---|---|---|---|---|---|
| Sample | Whiteness | Smell | Mouthfeel | Sweetness | sensation | taste | taste |
| 1 | 4.6 | 3.8 | 4.3 | 2.8 | 3.9 | 2.6 | 4.4 |
| A | 3.4 | 3.1 | 3.5 | 4.5 | 3.3 | 2.3 | 3.1 |
| B | 2.4 | 2.1 | 2.4 | 0.5 | 2.0 | 3.3 | 2.1 |
| C | 2.1 | 1.9 | 2.5 | 0.8 | 2.1 | 3.1 | 2.3 |
| D | 2.7 | 2.5 | 3.1 | 0.5 | 2.5 | 2.8 | 2.3 |
| E | 1.1 | 1.5 | 2.0 | 0.1 | 0.6 | 3.6 | 1.3 |
| F | 1.8 | 2.5 | 1.6 | 1.6 | 2.0 | 3.4 | 2.1 |
| G | 4.4 | 3.6 | 3.3 | 0.9 | 2.8 | 2.6 | 3.1 |
| H | 2.3 | 2.6 | 1.6 | 0.4 | 1.0 | 3.1 | 1.6 |
| I | 1.4 | 1.6 | 2.3 | 3.0 | 2.4 | 3.1 | 2.2 |

### Example 4

A spray-dried creamer composition was prepared as described in Example 1 of WO 2016/008742. Whole milk, dairy cream and sugar were mixed to provide an emulsion having the composition shown in Table 6.

TABLE 6

| | Wt. % |
|---|---|
| Whole milk | 71.8 |
| Cream (40% fat) | 7.6 |
| Sugar (sucrose) | 20.6 |

The emulsion was spray dried using the following procedure:
A wet mix was prepared by mixing 597 kg whole milk and 20.6 kg sugar. Then, 16.9 kg of cream (40% fat) was added; The mix was UHT treated at 102° C. for 5 seconds (DSI-type pasteurization, at 18% solids); Evaporation until 53% DM (53-55%);
Homogenisation 200 bar;
Spray drying, at moderate and mild pressure and temperatures (160° C.).

The composition of the spray dried powder so obtained is shown in Table 7.

TABLE 7

| | Wt. % |
|---|---|
| Protein | 19.5 |
| Fat | 26.3 |
| Sugar (sucrose) | 20.0 |
| Moisture | 3.0 |

The bulk density, particle size distribution and GTVV of the spray dried powder is shown in Table 8.

TABLE 8

| d₁₀ | d₅₀ | d₉₀ | D[3, 2] | D[4, 3] | Poured bulk | GTVV |
|---|---|---|---|---|---|---|
| (μm) | (μm) | (μm) | (μm) | (μm) | density (g/L) | (%) |
| 35 | 73 | 142 | 60 | 82 | 420 | 10.0 |

5.9 grams of the powder was filled into plastic capsules from Bisio Progetti, Italy, New Pod EVO Oxygen Barrier, diameter 37 mm, volume 12.6 ml, leaving a headspace of 2 mm (9 volume %) in each capsule. The capsules were sealed with aluminium cover seal from Bisio Progetti, supplied with the capsules.

The powder extraction rate was measured in the same way as in Example 2. The measured extraction rate was 74.8%.

### Example 5

Example 1 was repeated, except that this time only half the amount of sucrose was added to the pre-emulsion and that the water content was slightly reduced to achieve the same dry matter content. Sucrose was separately added to the agglomerated powder after the final drying step to produce a dry mix having the same composition as the agglomerated powder of Example 1.

The particle size distribution of the agglomerated spray dried powder is shown in Table 9.

TABLE 9

| d₁₀ | d₅₀ | d₉₀ | D[3, 2] | D[4, 3] |
|---|---|---|---|---|
| (μm) | (μm) | (μm) | (μm) | (μm) |
| 58 | 166 | 415 | 116 | 211 |

The blend of the agglomerated spray dried powder and sucrose had a poured bulk density of 436 g/L and a GTVV of 8.4%.

6.2 grams of the powder blend was filled into plastic capsules from Bisio Progetti, Italy, New Pod EVO Oxygen Barrier, diameter 37 mm, volume 12.6 ml, leaving a headspace of 2 mm (9 volume %) in each capsule. The capsules were sealed with aluminium cover seal from Bisio Progetti, supplied with the capsules.

The powder extraction rate was measured in the same way as in Example 2. The measured extraction rate was 80.5%.

### Example 6

Example 1 was repeated, except that amounts of sucrose, condensed skim milk, milk cream (40 wt. % fat) and skim milk powder were adjusted to produce pre-emulsions having the compositions shown in Table 10.

TABLE 10

| | Pre-emulsion 1 | Pre-emulsion 2 |
|---|---|---|
| | (wt. %) | (wt. %) |
| Sucrose | 19.8 | 9.1 |
| Condensed milk | 38.5 | 41.7 |
| Milk cream | 24.3 | 18.7 |
| Skim milk powder | 8.4 | 9.9 |
| Milk protein concentrate | 9 | |
| MPC80) | | |
| Lactose | | 20.6 |

The particle size distributions of the agglomerated spray dried powders so obtained are shown in Table 11.

TABLE 11

| Agglomerated | d₁₀ | d₅₀ | d₉₀ | D[3, 2] | D[4, 3] |
|---|---|---|---|---|---|
| Powder | (μm) | (μm) | (μm) | (μm) | (μm) |
| 1 | 68 | 216 | 525 | 139 | 266 |
| 2 | 85 | 273 | 739 | 174 | 367 |

The compositions, poured bulk density and GTVV of the blends of spray dried powder and post-added sucrose is shown in Table 12.

TABLE 12

| | Blend 1 | Blend 2 |
|---|---|---|
| | (wt. %) | (wt. %) |
| Protein | 19.1 | 17.3 |
| Fat | 18.1 | 14.3 |
| Sugar | 28.3 | 21.0 |
| Moisture | 2.5 | 3.5 |
| Poured bulk density | 416 g/L | 484 g/L |
| GTVV | 8.3% | 8.4% |

6.2 grams of the powder blends was filled into plastic capsules from Bisio Progetti, Italy, New Pod EVO Oxygen Barrier, diameter 37 mm, volume 12.6 ml, leaving a headspace of 2 mm (9 volume %) in each capsule. The capsules were sealed with aluminium cover seal from Bisio Progetti, supplied with the capsules.

The powder extraction rates was measured in the same way as in Example 2. The measured extraction rate were as follows:

Blend 1: 85.5%

Blend 2: 87.0%

1.-15. (canceled)

16. A sealed capsule for use in a coffee brewing apparatus, the capsule comprising a particulate composition, the composition comprising:
(a) 8-32 wt. % fat;
(b) 15-29 wt. % milk protein;
(c) 40-60 wt. % of disaccharide comprising, by weight of the disaccharide:
(i) 46-78 wt. % lactose; and
(ii) 22-54 wt. % sucrose.

17. The capsule according to claim 16, having an inner volume between 5-20 ml.

18. The capsule according to claim 17, having an inner volume between 10-15 ml.

19. The capsule according to claim 16, containing 4-8 grams of the particulate composition.

20. The capsule according to claim 19, containing 5-7 grams of the particulate composition.

21. The capsule according to claim 16, wherein the combination of fat, milk protein and disaccharide constitutes at least 85 wt. % of the particulate composition.

22. The capsule according to claim 16, wherein the particulate composition has a poured bulk density of 380-550 g/l.

23. The capsule according to claim 16, wherein the particulate composition has a volume weighted average particle size D[4,3] of 150-450 μm.

24. The capsule according to claim 16, wherein the particulate composition comprises fat and milk protein in a weight ratio in the range of 1:1.3 to 2.8:1.

25. The capsule according to claim 16, wherein the particulate composition comprises:
(a) 77.5-100 wt. % of spray dried particles comprising:
(i) 8-33 wt. % fat;
(ii) 15-29 wt. % milk protein;
(iii) 18-47 wt. % lactose; and
(iv) 7-18 wt. % sucrose; and
(b) 0-22.5 wt. % of sucrose particles.

26. The capsule according to claim 25, wherein the particulate composition comprises:
(a) 80-98 wt. % of the spray dried particles; and
(b) 2-20 wt. % of sucrose particles.

27. The capsule according to claim 25, wherein the spray dried particles comprise:
(i) 15-30 wt. % fat;
(ii) 18-26 wt. % milk protein;
(iii) 25-42 wt. % lactose; and
(iv) 8-17 wt. % sucrose.

28. The capsule according to claim 16, comprising at least 5 vol. % headspace.

29. A method for preparing a hot creamy liquid, comprising:
(a) placing the sealed capsule according to claim 16 in a coffee brewing apparatus,
(b) injecting hot water at a pressure of 4 bar to 20 bar into the capsule to form a hot creamy liquid, and
(c) dispensing the hot creamy liquid from the capsule.

30. The method according to claim 29, wherein 30-100 ml of hot creamy liquid is dispensed from the capsule.

31. The method according to claim 29, wherein at least 85 wt. % of the milk protein in the particulate composition is removed from the capsule with the hot creamy liquid.
